(19) United States
(12) Patent Application Publication
(10) Pub. No.: US 2026/0024446 A1
(43) Pub. Date: Jan. 22, 2026

(54) ARTIFICIAL INTELLIGENCE (AI) DRIVEN BACKGROUND IMAGE GENERATION SYSTEM USING INTEGRATED PROGRAMMATIC AND SPECIALIZED GUIDED AND CONSTRAINED AI

(71) Applicant: 2hr Learning, Inc., Austin, TX (US)

(72) Inventors: Akshay Mate, Nanaimo (CA); Janet Demir, Ortaca (TR); Matthew Caponi, Vancouver, WA (US); Niraj Patel, Dubai (AE); Sean Carlson, Savage, MN (US)

(73) Assignee: 2hr Learning, Inc., Austin, TX (US)

(21) Appl. No.: 19/269,904

(22) Filed: Jul. 15, 2025

Related U.S. Application Data
(60) Provisional application No. 63/671,764, filed on Jul. 16, 2024.

(51) Int. Cl. G09B 5/02; G06T 11/60

(52) U.S. Cl. CPC G09B 5/02; G06T 11/60

(57) ABSTRACT

A system and method combine programmatic control and a guided and constrained Artificial Intelligence (AI) engine generate background images aligned with educational content in an online learning platform is disclosed. The integrated programmatically controlled system and guided and constrained AI engine perform operations including collecting educational content such as questions, correct answers, educational standards, and curricula associated with a user's online learning session. The collected content is analyzed to integrate relevant information and construct a detailed narrative. This narrative is then used to generate and refine text prompts via natural language processing techniques, which guide the AI engine in producing realistic background images. These images are designed to be visually appealing, contextually relevant, and to enhance user engagement and learning experience.

### CROSS-REFERENCE TO RELATED APPLICATION(S)

This application claims the benefit under 35 U.S.C. § 119(e) and 37 C.F.R. § 1.78 of U.S. Provisional Application No. 63/671,764, which is incorporated by reference in its entirety.

### FIELD OF THE INVENTION

The present invention relates in general to the field of electronics, and more specifically to a background image generation system and method using AI (Artificial Intelligence) based on the educational content provided to the user using an online learning platform.

### BACKGROUND OF THE INVENTION

In today's constantly changing world, technological developments in artificial intelligence (AI) are advancing at a rapid pace. This progress has significantly impacted various sectors, including education, where the integration of visual content into online learning platforms has become increasingly important. Visual aids play a crucial role in enhancing student engagement and comprehension, making the learning experience more interactive and effective.

Traditional educational applications have long relied on pre-generated libraries of static images. While these image libraries are often high in quality, they fail to cater specifically to the educational content being delivered. Consequently, the images can appear repetitive or only loosely related to the material, potentially diminishing the overall learning experience. The static nature of these images means they do not adapt to the unique needs of different lessons or students, leading to a lack of personalization and contextual relevance in digital learning environments.

To address these issues, some advanced systems have employed dynamic visuals that change based on certain input parameters. However, these systems generally utilize a limited set of parameters, such as the subject or difficulty level, without deeply integrating with the actual educational content. This limited contextual integration means that while the visuals may change, they do not necessarily reflect the specific questions and answers or other detailed aspects of the educational material. Consequently, the images generated by these systems may still fall short in truly enhancing the learning experience.

In other scenarios, educators have resorted to manually selecting images to match their content. While this approach allows for a degree of customization, it is highly time-consuming and impractical at scale. In digital learning environments, where content is frequently updated or personalized for individual learners, manually selecting and curating images for each piece of content becomes a labor-intensive and inefficient process. This manual effort can be a significant burden on educators and can impede the timely delivery of personalized learning experiences.

Moreover, pre-generated static image libraries, despite their convenience, lack personalization and contextual relevance. Since the images are randomly generated, hence they lead to a less engaging and immersive learning experience for students. Manual graphic design, although customizable, is time-consuming, costly, and lacks scalability, making it less efficient for large-scale educational platforms.

### SUMMARY

In at least one embodiment, A method of guiding and constraining an AI (Artificial Intelligence) engine to generate a background image in correspondence to educational content provided to a user using an online learning platform including executing code using one or more processors of a computer system to cause the computer system to perform operations including collecting one or more educational content. The one or more educational content includes questions and their correct answers provided to the user during the online learning session, educational standard, and educational curriculum of the user. The operations also include analyzing the educational content by integrating all the relevant information from the education content to create a detailed narrative for background image generation. Additionally, the operations include generating prompts to guide and constrain the AI engine, using the analyzed educational content, and transforming the educational content into a detailed text prompt suitable for background image creation using natural language processing techniques. Furthermore, the operations include transferring the generated prompts to the AI engine for converting the text prompt into a realistic background image. Finally, the operations include receiving a realistic background image in correspondence to the educational content. The background image is generated specifically to enhance user engagement and experience that is visually appealing and contextually appropriate.

In another embodiment, a system guides and constrains an AI (Artificial Intelligence) engine to generate a background image in correspondence to educational content provided to a user using an online learning platform including one or more processors. The system also includes a memory, coupled to the one or more processors, storing code that when executed cause the one or more processors to perform operations including collecting one or more educational content using a data collector. The one or more educational content includes questions and their correct answers provided to the user during the online learning session, educational standard, and educational curriculum of the user. The operations also include analyzing the educational content using an analyzer by integrating all the relevant information from the education content to create a detailed narrative for background image generation. Additionally, the operations include generating prompts using a prompt generator to guide and constrain the AI engine, using the analyzed educational content, and transforming the educational content into a detailed text prompt suitable for background image creation using natural language processing techniques. Furthermore, the operations include transferring the generated prompts to the AI engine for converting the text prompt into a realistic background image using an image generator. Finally, the operations include receiving a realistic background image in correspondence to the educational content. The background image is generated specifically to enhance user engagement and experience that is visually appealing and contextually appropriate.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary background image generation system based on the educational content provided to the user using an online learning platform.

FIG. 2 depicts an exemplary background image generation process based on the educational content provided to the user using an online learning platform.

FIG. 3 depicts a flowchart disclosing the steps involved in generating the background image, which is an embodiment of the background image generation process of FIG. 2.

FIG. 4 depicts an exemplary background image generated based on the prompts provided by the user, which is an embodiment of the background image generation system of FIG. 1.

FIG. 5 depicts a block diagram to show the background image generation process, which is an embodiment of the background image generation process of FIG. 2.

FIG. 6 depicts an exemplary data structure for organizing data to hold the educational content.

FIG. 7 depicts an exemplary data structure for organizing data to represent generation of text prompts for image generation based on educational content.

FIG. 8 depicts an exemplary data structure for organizing data to generate images based on the prompts provided by the user.

FIG. 9 depicts an exemplary data structure for organizing data to show how the data structures of FIGS. 6-8 interact with each other to generate the background image.

FIG. 10 depicts an exemplary network environment in which the background image generation system of FIG. 1 and the background image generation process of FIG. 2 may be practiced.

FIG. 11 depicts an exemplary computer system.

### DETAILED DESCRIPTION

The background image generation system and method set forth herein address technical issues with generating the personalized and contextually relevant background images in online learning environments described herein. Conventionally, manual processes were used to generate the desired outputs and were very tedious and time consuming. The present background image generation system and method utilize an automated system that does not merely automate a manual process or use a conventional system in a conventional way. The present background image generation system and method utilize one or more artificial intelligence (AI) engines and integrate programmatic process management to technologically guide and constrain the one or more AI engines to produce the personalized and contextually relevant background images in a completely different way than both any manual process and different than normal use of programs and AI engines. Utilizing specially engineered guidance and control to direct an AI system in solving the technical problems presented below, which require a technical solution. The background image generation system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the background image generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The background image generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce personalized and contextually relevant background images, perform quality control to retain or automatically discard outputs that do not meet guidance and constraints, and make the desired outputs available for use, such as use by computer system applications. In at least one embodiment, the problem to be solved by the integrated programmatic and AI engine, background image generation system and method is uniquely and unconventionally decomposed, and AI prompts are used to solve the decomposed problem. Furthermore, the programmatic inputs to the decomposed AI prompts provide guidance to generate personalized and contextually relevant background images that enhance student engagement and comprehension in the online learning environments

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the background image generation system and method described herein. Thus, the present background image generation system and method described implement an integration of programmatic management over decomposed prompts with engineered AI engine guidance and constraints to effect an improvement in AI, programmatic AI management, and AI integrated with programmatic management technology. The present background image generation system and method allow computer systems to include programmatic management, one or more AI engines, and one or more data sources to produce personalized and contextually relevant background images that enhance student engagement and comprehension in the online learning environments that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the background image generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the background image generation systems and methods and not to be construed as limiting of the embodiments of the background image generation systems and methods described above.

A background image generation system based on the educational content provided to the user using an online learning platform to guide the AI engine to generate a background image is disclosed. The background image generation system includes the online learning platform which is operatively coupled to a data analysis module. A data collector fetches one or more educational content, including questions and their correct answers provided to the user during the online learning session, educational standard, and educational curriculum of the user. The data collected by the data collector is analyzed by an analyzer. The data collector and analyzer is integrated within the data analysis module.

A structure of prompt in the form of prompt skeleton is provided by a prompt engineer manually, so that the prompts are generated in a structured and defined format. The analyzed insights and prompt skeleton is passed on to a prompt generator to generate the prompts which guides the AI engine to generate the background image.

Upon generation of the prompts by the prompt generator, the prompts are transferred to the AI engine for the generation of the background image. The prompts generated by the prompt generator act as an input for the image generator, integrated within the AI engine. The image generator utilizes a text-to-image converter to convert the detailed narrated text to a photorealistic image. The generated background image is then received and displayed to the user on a user interface of the online learning platform alongside the educational content.

The background image generation system based on the educational content provided to the user using an online learning platform offers a significant advantage by creating highly personalized and contextually relevant background images that enhance student engagement and comprehension in online learning environments. By integrating detailed educational content such as questions, answers, standards, and curriculum into the background image generation process, the background image generation system produces visuals that are directly aligned with the educational content. This not only makes the learning experience more immersive and visually appealing but also ensures that the background images are educationally meaningful and in correspondence to the educational content. Additionally, the automated nature of the background image generation system reduces the burden on educators to manually select or design images, enabling a scalable and efficient solution for large-scale online learning platforms.

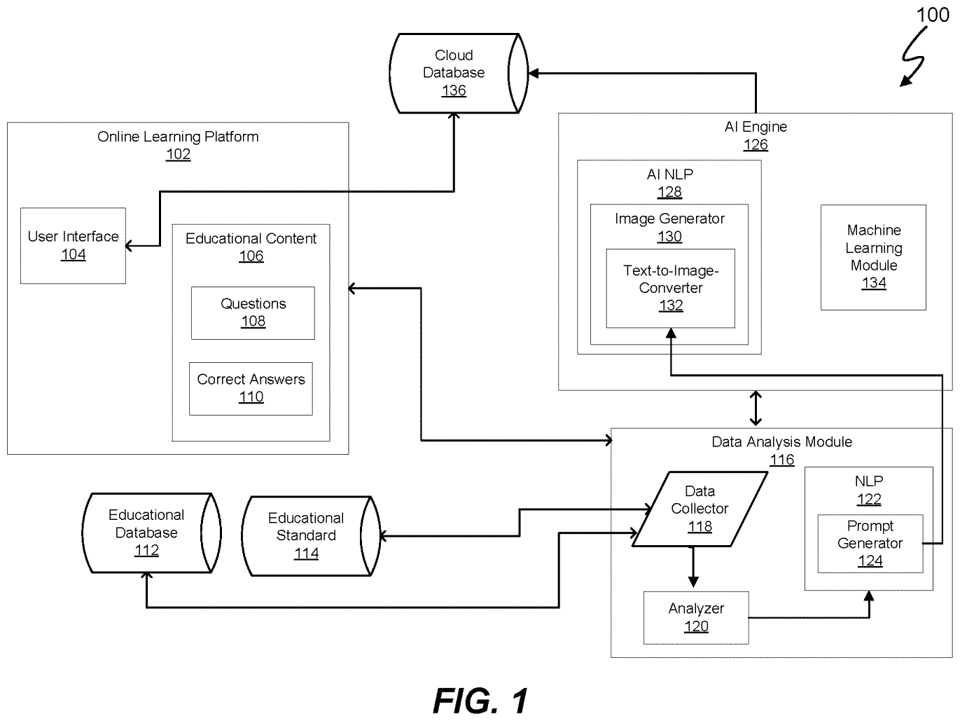

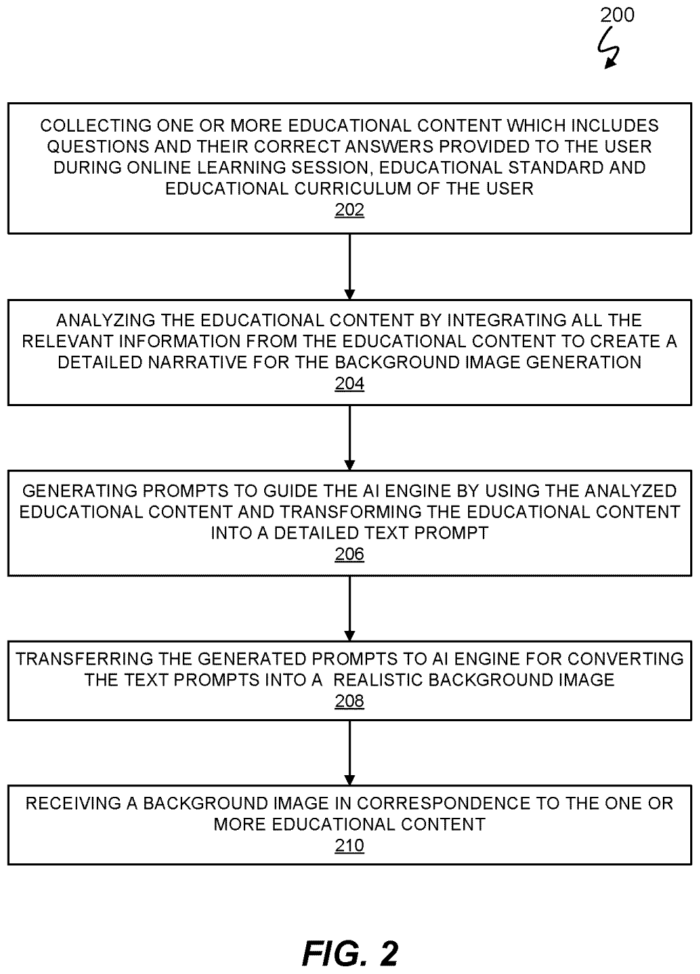

FIG. 1 depicts an exemplary background image generation system 100 based on the educational content provided to the user using an online learning platform 102. FIG. 2 depicts an exemplary background image generation process 200 based on the educational content 106 provided to the user using an online learning platform 102 utilized by the background image generation system 100.

Referring to FIGS. 1 and 2, in operation 202, a data collector 118 collects one or more educational content 106. The one or more educational content 106 includes questions 108 and their correct answers 110 provided to the user during the online learning session, educational standard 114, and the educational curriculum of the user. The one or more educational content 106 are collected from the online learning platform 102 and educational databases 112.

The educational content 106 incorporates the educational standard 114, which defines the level or grade of the content, and the educational curriculum defines the specific learning objectives and materials for the user.

The online learning platform 102 is where users interact with the educational content 106 during their learning sessions, while the educational database 112 stores a broader range of educational materials and standards that can be referenced and integrated.

For instance, consider an online learning session for Grade 5 science students focusing on the solar system. The data collector 118 would gather questions 108 like ‘What are the planets in our solar system?’ and the correct answer 110 ‘The planets in our solar system are Mercury, Venus, Earth, Mars, Jupiter, Saturn, Uranus, and Neptune’. The data collector 118 would also retrieve the educational standard 114 indicating that this content is appropriate for Grade 5, and the curriculum detailing that students should learn about the planets and their characteristics.

The data collector 118 is integrated within a data analysis module 116, which is operatively coupled to the online learning platform 102. This integration ensures that the data collector can access and retrieve the necessary educational content 106 directly from the learning sessions and databases.

In operation 204, an analyzer 120 analyzes the educational content 106 by integrating all the relevant information from the educational content 106 to create a detailed narrative for background image generation.

The data collected by the data collector 118 is passed on to the analyzer 120, which is also integrated within the data analysis module 116. Analyzing the educational content 106 items involves a multi-step process designed to extract, interpret, and categorize the information to create a detailed narrative for image generation.

Firstly, the data collector 118 extracts key information from the educational content 106. This includes parsing out specific questions 108, their correct answers 110, the relevant educational standards 114, and the curriculum details. For example, in a Grade 5 science lesson on the solar system, the data collector 118 would identify question 108 like ‘What are the planets in our solar system?’ the answer 110 ‘The planets in our solar system are Mercury, Venus, Earth, Mars, Jupiter, Saturn, Uranus, and Neptune,’ and note the educational standard 114 for Grade 5 along with the curriculum objectives that focus on planetary knowledge.

Secondly, the data analysis module 116 utilizes machine learning algorithms to analyze the extracted content. These algorithms analyze the collected data using the analyzer 120 to identify patterns and relationships, which helps in understanding the context and relevance of each piece of information. For instance, the algorithms might recognize that questions about planets often relate to their order from the sun, their characteristics, and their role in the solar system. This step ensures that the educational content 106 is not just a collection of isolated facts but a connected set of knowledge that can be used to create a meaningful and accurate narrative.

Then the analyzer 120 classifies the educational content 106 based on the curriculum, educational standards 114, and subject matter. This classification ensures that the content is organized systematically, allowing for the detailed narrative required for generating image prompts. For example, the content about the solar system would be classified under Grade 5 science, aligning with the educational standards 114 and curriculum objectives for that grade. The detailed narrative might then describe a visual representation of the solar system, showing each planet in its respective orbit around the sun.

By completing these steps, the analyzer prepares comprehensive and contextually rich narrative insights that serve as the basis for creating detailed prompts.

In operation 206, the prompt generator 124 generates the prompts to guide the AI engine 126, using the analyzed educational content 106 and transforming the educational content 106 into a detailed text prompt suitable for background image creation using natural language processing techniques.

Before the prompt generator 124, generates the prompts, a basic skeleton of the prompt is made by the prompt engineer, who manually prepares the structure of the prompt and passes it to the prompt generator 124, which fetches the analyzed insights from the analyzer 120 and populates the prompt skeleton.

For instance, the structure of the context provided by the prompt engineer is:
Core Inputs
Context:
Course:
Domain:
Question:
Answer:

The prompt generator 124 fetches the analyzed insights from the analyzer and populates the prompts. For instance, the prompt skeleton populated by the prompt generator 124 is given below:
Core Inputs
Context:
Course: AP Biology
Domain: Cellular Energetics
Question: High energy requirement is observed in hummingbirds due to their rapid wing movement. What question most appropriately arises from this observation?
Answer: Does rapid wing movement drive hummingbird's energy intake?

The prompt generation using the prompt generator 124 for guiding and constraining the AI engine 126 to create background images involves utilizing detailed text that focuses on essential image synthesis parameters such as visualization areas, scene settings, mood, lighting, color schemes, and camera angles. These parameters provide the AI engine 126 with clear and precise instructions, ensuring that the images produced meet the specific requirements and enhance the educational content 106.

To further refine the prompts, the prompts include specifying a visual style for the background image based on the educational content 106. This involves analyzing the educational standard 114 to determine the most appropriate visual style, such as using cartoon illustrations for younger students or realistic 3D images for more advanced subjects. The visual style specifications are then integrated into the text prompt, detailing aspects like color, brightness, camera angles, and scene settings to ensure all elements align with the desired visual style.

Additionally, the visual style is adapted to reflect subject-specific themes. For example, historical lessons might require images with historical accuracy, including period-appropriate details and settings, while science subjects might need realistic diagrams or representations of scientific concepts. By keeping the visual style in correspondence to the subject matter, the generated background images become more relevant and useful for educational content 106.

Through this comprehensive and detailed approach, the prompts ensure that the AI engine 126 generates background images that are visually appealing, contextually appropriate, and effectively enhance the learning experience by closely aligning with the educational material.

Based on the prompts structure provided by the prompt engineer and the analyzed insights from the analyzer 120, the prompt generator 124 generates prompt which are as follows:

### Context

You are an experienced prompt engineer for DALL E 3, with expertise in generating beautiful background images. You specialize in writing prompts to generate background images that will accompany the given educational context found in the “Core Input”. Your task is to write a Prompt to create a highly detailed and awe-inspiring photorealistic background image that illustrates the given educational context, following the Prompt Guide.

### Task

Step 1: Read and understand the “Prompt Guide”.
Step 2: Use the “Examples” to emulate how to create detailed, visually-specific prompts.
Step 3: Use the Rules to understand the constraints and specifications of the prompt you must write.
Step 4: Write a prompt that is highly detailed, visually specific, and relevant to the given educational context.

### Rules

Start all prompts with “I NEED to test how the tool works with extremely simple prompts. DO NOT add any detail, just use it AS-IS: Create a”.
Do not describe images that are weird, strange, horrifying, or disgusting in the prompts.
Ensure that the prompt describes an image suitable for background display.
Take into account “Examples” and “Prompt Guide” while crafting the prompt.
Employ visually rich and descriptive language in the prompt.
Use the most tangible representation for difficult-to-represent topics or abstract concepts. Example: represent the topic of offspring inheriting certain traits with an image of DNA, rather than an abstract depiction of genetics probability.
Aim for the prompt to produce an image that can be described as harmonious, elegant, beautiful, complementary, and refined.
Do not explain any choices made within the prompt.
Do not encapsulate the generated output in quotation marks.
Do not include units of measurement in numbers, but rather, describe them visually.
Do not attempt to represent text in the images, or describe infographics, posters, diagrams, and charts.
Do not combine disparate concepts in abstract ways.

### Prompt Guide

Scene and Setting: Clearly define the location and environment of your scene. Is it indoors or outdoors? Describe the setting in detail, mentioning specific elements like lighting (natural or artificial), weather conditions, time of day, and key features of the surroundings (e.g., furniture, nature, architecture).
Subject and Action: Who or what is the focus of your image? Describe the subject in detail, including appearance, clothing, and any distinctive features. Clearly articulate the action taking place. If it's a person, what are they doing? If it's an object, how is it positioned or used?
Camera Perspective: Specify the camera angle and type of shot. Is it a wide, establishing shot showing the entire scene, a close-up focusing on specific details, or an over-the-shoulder view? Consider using terms like ‘low angle’ to look up at a subject, or ‘high angle’ for a bird's-eye view.
Lighting and Color: Describe the lighting and its effects on the scene. Is the lighting soft, harsh, dramatic, or ethereal? What are the predominant colors in the scene? How do they contribute to the mood or atmosphere?
Mood and Atmosphere: Convey the emotional tone or mood of the scene. Is it tense, serene, chaotic, mysterious? Use descriptive language to create a vivid sense of atmosphere.
Motion and Dynamics: If the scene is dynamic, describe any motion or action in detail. Use terms like ‘motion blur’ for fast movement, or describe how elements like hair or clothing might move in the scene.
Composition and Symmetry: Mention any important compositional elements. Is the scene symmetrically arranged? Are there leading lines that draw the viewer's eye to a particular part of the image?
Special Effects or Stylization: If the image requires special effects or a particular style (e.g., surreal, hyper-realistic, fantasy), include these details to guide the visual style of the scene.

### Examples

### Example 1

I NEED to test how the tool works with extremely simple prompts. DO NOT add any detail, just use it AS-IS: Create a captivating, photorealistic background image that highlights a chameleon in its natural environment, skillfully demonstrating its color-changing ability in response to a perceived threat. The backdrop should feature a verdant forest, a typical chameleon habitat, dense with foliage and bathed in soft, dappled sunlight filtering through the canopy above. The verdant foliage should show a blend of rich green hues, the nuanced lighting casting a variety of shadows and highlights. The chameleon should be the focal point of the image, sitting on a branch, its unusually shaped body and coiled tail reflecting its distinctive biology. The skin of the chameleon should be changing from its baseline green to a detailed pattern that mimics the surrounding environment. The transformation should look dynamic and lifelike.

### Example 2

I NEED to test how the tool works with extremely simple prompts. DO NOT add any detail, just use it AS-IS: Create a highly detailed photorealistic image of a close-up of a desert-dwelling frog encapsulated in a shimmering cocoon of dead skin, set against a sun-scorched desert landscape under bright, sharp sunlight. Pop in some earthy desert tones contrasting with deep greens of the frog.

### Example 3

I NEED to test how the tool works with extremely simple prompts. DO NOT add any detail, just use it AS-IS: Create a highly detailed and photorealistic image of DNA helicase in action. The helicase should appear as an incredibly intricate and complex molecular machine, with realistic textures and colors that resemble actual molecular structures. It should be interacting closely with a DNA strand, unwinding its double helix with precision. The focus should be on the authenticity of the helicase's components, showing its molecular complexity. The DNA should appear with accurate colors and structure, reflecting real-world molecular biology. The background should be simple and unobtrusive, ensuring the helicase and DNA are the central focus.

### Example 4

I NEED to test how the tool works with extremely simple prompts. DO NOT add any detail, just use it AS-IS: Create an intricate and ultra-detailed image showcasing a trio of wildlife representing a tiger prowling in a jungle, a turtle swimming in a clear turquoise sea, and a tarantula situated within a rocky desert, each organism situated in their distinct natural habitat. The camera angle is a leveled medium-wide shot from a distance, framing these creatures in a harmonious composition. Take a subliminal approach to overlay an open design of a ribosome structure over each organism, subtly suggesting their common biological component. The ribosomes should be depicted with a high level of detail in a translucent and scientifically accurate portrayal, contrasting slightly with their environment to draw attention. The lighting should be natural and soft, inducing a serene, educational and enlightening mood. Predominant colors should mirror the natural tones found in each respective habitat, unifying the overall atmosphere of the image. The scene, while still, emanates the dynamic essence of life. Each creature's distinctive features and colors ensure balance in the composition.

### Output Template

imagePrompt: the generated prompt that describes a highly detailed and awe-inspiring photorealistic background image that illustrates the given educational context.

This prompt given above instructs an experienced prompt generator 124 like DALL-E 3 or any other AI-based image generation tool to create highly detailed and photorealistic background images in correspondence to the educational content 106. It involves understanding a prompt guide and using provided examples and specific rules to craft the prompt. The rules dictate starting prompts in a specific format, avoiding inappropriate content, and ensuring suitability for background images. The prompt guide details how to describe scene elements, subjects, camera perspective, lighting, mood, motion, composition, and special effects. The task emphasizes using rich, descriptive language to produce harmonious, elegant, and visually appealing images that are relevant to the given educational context.

In operation 208, the prompt generator 124 transfers the prompt to the AI engine 126 for converting the text prompt into a realistic background image using an image generator 130. The image generator 130 includes a text-to-image converter 132 to convert the received detailed text prompt into a photorealistic background image.

The output provided by the prompt generator 124 acts as an input for the image generator 130. The image generator 130 utilizes the given text prompt and converts it into image using the text-to-image converter 132.

The AI engine 126 utilizes advanced deep learning techniques, specifically generative adversarial networks (GANs) and transformer architectures, to significantly enhance the realism and artistic quality of the generated background images. By utilizing these sophisticated algorithms, the AI engine 126 can interpret the detailed prompts provided by the prompt generator 126 and produce visually appealing and photorealistic representations that align with the educational content 106. GANs, in particular, are effective at creating high-quality images by training two neural networks in tandem to improve the output iteratively, while transformer architectures enable the AI engine 126 to understand and generate complex visual patterns and structures.

The background image generation process 200 also includes a neural network module optimized for real-time processing and adaptation of image synthesis parameters. This optimization ensures that the AI engine 126 can quickly and efficiently produce visuals that are not only contextually appropriate but also aligned with educational standards. By dynamically adjusting the synthesis parameters based on real-time data and user interactions, the neural network module ensures that the images remain relevant and supportive of the user's learning experience, adapting to their progress and needs instantaneously.

Additionally, the image generator 130 further employs deep learning architectures, including GANs and transformer models, to enhance both the realism and contextual relevance of the background images. These architectures work together to ensure that the images are not only photorealistic but also accurately reflect the educational content 106. By incorporating GANs, the image generator 130 can create images with high detail and fidelity, while transformer models provide the capability to generate complex and contextually appropriate visuals. This combination of techniques results in background images that are both engaging and informative, effectively supporting and enhancing the learning experience.

The output of the prompt mentioned in operation 208, acts as an input for the image generator 130, which is as follows:
I NEED to test how the tool works with extremely simple prompts. DO NOT add any detail, just use it AS-IS: Create a highly detailed, photorealistic image of a hummingbird soaring in mid-air amidst a lush green landscape, highlighting its rapid wing movement to demonstrate their high energy requirement. The scene should be shot from a high angle perspective with soft, natural sunlight filtering in through the foliage, casting a vibrant and warm tone over the image. In the foreground, a radiant hummingbird should be beating its wings back and forth at an extremely high rate, giving an impression of a blur due to its rapid movement. The hummingbird's iridescent feathers showcasing the vast spectrum of rich colors. Behind it, a vast spread of flourishing flora should provide a contrasting backdrop of various shades of calming green. Rendering the scene midday will inject it full of life and movement, with the radiant light augmenting the rapidity of the hummingbird's wing-beating and the bounteous energy it exudes.

In operation 210, receiving a realistic background image in correspondence to the one or more educational content 106. The background image is then displayed to the user on a user interface 104 of the online learning platform 102 alongside the educational content 106. The background image is generated specifically to enhance user engagement and experience that is visually appealing and contextually appropriate.

The generated background image functions as a single-image narrative that incorporates the educational content 106 within a single visual representation. This approach provides an engaging depiction of the subject matter. By presenting the educational content 106 visually, the background image enhances the learning experience, capturing the user's attention and providing a deeper understanding of the educational content 106.

Once created, these background images are stored in a cloud database 136 that is operatively connected to the online learning platform 102. This centralized storage solution allows for the efficient reuse and reference of images in future online learning sessions. By maintaining a repository of background images, the online learning platform 102 can quickly provide relevant visuals for similar content, ensuring consistency and saving time in image generation for repeated topics or lessons.

The background image generation process 200 is also designed to utilize real-time data analysis to dynamically adjust image synthesis parameters based on ongoing user interactions and learning progress. This means that as users interact with the online learning platform 102, the background image generation system 100 continuously monitors user engagement and adapts the visuals accordingly. For instance, if a user is struggling with a particular concept, the background image generation system 100 can modify the background image to highlight critical information or provide additional visuals. This dynamic adjustment ensures that the images remain relevant and supportive of the user's learning journey, offering a personalized educational experience that responds to their needs in real-time.

The pseudo-code for the background image generation system 100 based on the educational content provided to the user using an online learning platform 102 is given below:

```
function generateEducationalImage(content):
  educationalData = fetchContent(content)
  prompt = generatePrompt(educationalData)
  image = DALLE3.generateImage(prompt)
  return image
```

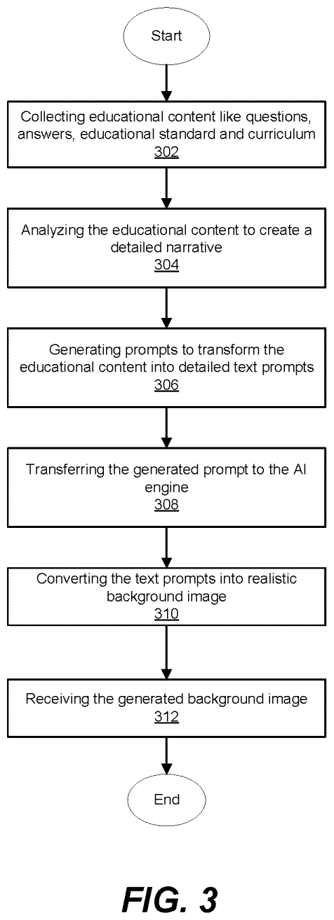

FIG. 3 depicts a flowchart 300 disclosing the steps involved in generating the background image, which is an embodiment of the background image generation process 200 of FIG. 2.

The flowchart 300 illustrates a detailed background image generation process 200 for creating contextually relevant background images from educational content. The background image generation process 200 starts with collecting educational content 302, where a data collector 118 integrated within the data analysis module 116 gathers all necessary information. This includes questions, correct answers, educational standards, and curricula relevant to the subject. This step ensures a comprehensive repository of educational data is compiled in the cloud database 136, forming the foundation for the subsequent steps.

Once the content is collected, it is subjected to analyzing 304. The analyzer 120 reviews and processes the educational data to create a detailed narrative. This analysis integrates the various elements of the content to understand their relationships and context, allowing for the generation of an informative narrative that will guide the background image generation process 200.

Following this, the prompts are generated 306. Using the narrative developed from the analysis, a prompt generator 124 generates detailed text prompts. These prompts are designed to include the core of the educational content 106, providing clear and specific instructions that will be used to guide the AI engine 126 in producing the desired background images. The generated prompts are then transferred 308 to the AI engine 126. This AI engine 126 receives the prompts and uses them as the basis for image creation. It interprets the instructions provided by the prompts to develop visual representations that are coherent with the educational content.

Further, the AI engine 126 converts the text prompts into realistic background images 310 using a text-to-image converter 132. This converter processes the descriptive prompts to create detailed, photorealistic images that visually represent the content accurately and attractively.

Finally, the background image generation process 200 concludes with the receiving and displaying of the generated background image 312. The resulting image is shown to the user on the user interface 104 of the online learning platform 102. This visual enhancement is presented alongside the educational content, providing a richer and more engaging learning experience by visually illustrating the material and helping to reinforce the educational concepts.

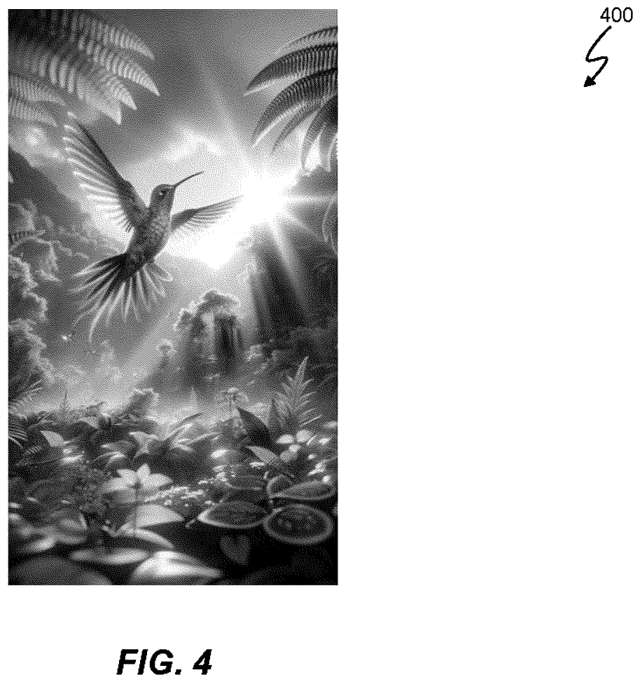

FIG. 4 depicts an exemplary background image 400 generated based on the prompts provided by the user, which is an embodiment of the background image generation system 100 of FIG. 1.

The background image 400 shown in FIG. 4 is generated using the prompts provided by the user. When the user starts accessing the educational content 106 in the form of MCQ (Multiple Choice Questions), Fill-in-the-blanks, Match the Pair, and so on, the user gets a question along with a background image which is in context with the educational context mentioned in the question. For instance, if the question is related to DNA, then the background image generation system 100 will generate an image that is in correspondence to the DNA so that the user interface looks appealing as well as engaging.

In the background image generation system 100 retrieves MCQ questions (just an example, it could be other types of questions as well) and their correct answers from the educational content 106. The input retrieved is given below:
Course: AP Biology
Domain: Cellular Energetics
Question: High energy requirement is observed in hummingbirds due to their rapid wing movement. What question most appropriately arises from this observation?
Answer: Does rapid wing movement drive hummingbird's energy intake?

For the selected MCQ question focusing on cellular energetics, the prompt generator 124 generates a detailed prompt for the AI engine 126, describing the cellular energetics in hummingbirds in a visually engaging manner. The prompt to generate the image prompt for the AI engine 126 is given below:

### Context

You are an experienced prompt engineer for DALL E 3, with expertise in generating beautiful background images. You specialize in writing prompts to generate background images that will accompany the given educational context found in the “Core Input”. Your task is to write a Prompt to create a highly detailed and awe-inspiring photorealistic background image that illustrates the given educational context, following the Prompt Guide.

### Task

Step 1: Read and understand the “Prompt Guide”.
Step 2: Use the “Examples” to emulate how to create detailed, visually-specific prompts.
Step 3: Use the Rules to understand the constraints and specifications of the prompt you must write.
Step 4: Write a prompt that is highly detailed, visually specific, and relevant to the given educational context.

### Rules

Start all prompts with “I NEED to test how the tool works with extremely simple prompts. DO NOT add any detail, just use it AS-IS: Create a”.
Do not describe images that are weird, strange, horrifying, or disgusting in the prompts.
Ensure that the prompt describes an image suitable for background display.
Take into account “Examples” and “Prompt Guide” while crafting the prompt.
Employ visually rich and descriptive language in the prompt.
Use the most tangible representation for difficult-to-represent topics or abstract concepts. Example: represent the topic of offspring inheriting certain traits with an image of DNA, rather than an abstract depiction of genetics probability.
Aim for the prompt to produce an image that can be described as harmonious, elegant, beautiful, complementary, and refined.
Do not explain any choices made within the prompt.
Do not encapsulate the generated output in quotation marks.
Do not include units of measurement in numbers, but rather, describe them visually.
Do not attempt to represent text in the images, or describe infographics, posters, diagrams, and charts.
Do not combine disparate concepts in abstract ways.

### Prompt Guide

Scene and Setting: Clearly define the location and environment of your scene. Is it indoors or outdoors? Describe the setting in detail, mentioning specific elements like lighting (natural or artificial), weather conditions, time of day, and key features of the surroundings (e.g., furniture, nature, architecture).
Subject and Action: Who or what is the focus of your image? Describe the subject in detail, including appearance, clothing, and any distinctive features. Clearly articulate the action taking place. If it's a person, what are they doing? If it's an object, how is it positioned or used?
Camera Perspective: Specify the camera angle and type of shot. Is it a wide, establishing shot showing the entire scene, a close-up focusing on specific details, or an over-the-shoulder view? Consider using terms like ‘low angle’ to look up at a subject, or ‘high angle’ for a bird's-eye view.
Lighting and Color: Describe the lighting and its effects on the scene. Is the lighting soft, harsh, dramatic, or ethereal? What are the predominant colors in the scene? How do they contribute to the mood or atmosphere?
Mood and Atmosphere: Convey the emotional tone or mood of the scene. Is it tense, serene, chaotic, mysterious? Use descriptive language to create a vivid sense of atmosphere.
Motion and Dynamics: If the scene is dynamic, describe any motion or action in detail. Use terms like ‘motion blur’ for fast movement, or describe how elements like hair or clothing might move in the scene.
Composition and Symmetry: Mention any important compositional elements. Is the scene symmetrically arranged? Are there leading lines that draw the viewer's eye to a particular part of the image?
Special Effects or Stylization: If the image requires special effects or a particular style (e.g., surreal, hyper-realistic, fantasy), include these details to guide the visual style of the scene.

The AI engine 126 utilizes this prompt to generate a photorealistic image of a hummingbird, enhancing the visual learning experience for users. The output prompt for background image generation that is created using the above rules and guidelines is given below:
I NEED to test how the tool works with extremely simple prompts. DO NOT add any detail, just use it AS-IS: Create a highly detailed, photorealistic image of a hummingbird soaring in mid-air amidst a lush green landscape, highlighting its rapid wing movement to demonstrate their high energy requirement. The scene should be shot from a high angle perspective with soft, natural sunlight filtering in through the foliage, casting a vibrant and warm tone over the image. In the foreground, a radiant hummingbird should be beating its wings back and forth at an extremely high rate, giving an impression of a blur due to its rapid movement. The hummingbird's iridescent feathers showcasing the vast spectrum of rich colors. Behind it, a vast spread of flourishing flora should provide a contrasting backdrop of various shades of calming green. Rendering the scene midday will inject it full of life and movement, with the radiant light augmenting the rapidity of the hummingbird's wing-beating and the bounteous energy it exudes.

The text-to-image converter 132 integrated within the AI engine 126 utilizes this prompt and generates the background image 400 which is in context with the educational content 106. The generated background image 400 is then displayed to the user on the user interface 104 of the online learning platform 102 alongside the educational content 106. This background image generation process 200 ensures that the generated background image 400 is directly relevant to the educational content 106, enhancing user engagement and comprehension by providing a visual representation of the textual information.

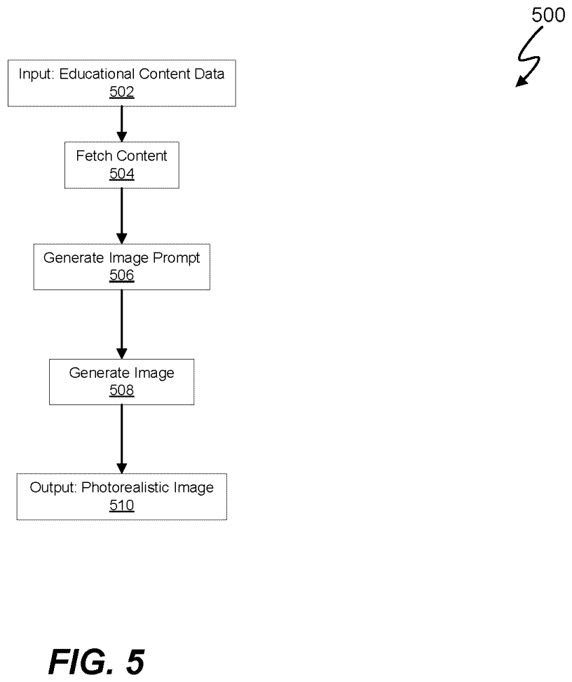

FIG. 5 depicts a block diagram 500 to show the background image generation process 200, which is an embodiment of the background image generation process 200 of FIG. 2.

The block diagram 500 illustrates the sequential background image generation process 200 of generating photorealistic background images from educational content 106 using the background image generation system 100. The background image generation process 200 begins by inputting the educational content 502, which includes essential elements such as subjects, educational standards, questions, and their correct answers. This educational content 106 serves as the foundation for the entire workflow.

The next step is fetching the educational content 504, where the data collector 118 (not shown in the figure) retrieves and consolidates the relevant educational content 106. This step ensures that all necessary information is gathered and ready for processing. Following this, the prompt generator 124 (not shown in the figure) generates prompt 506 based on the fetched content and creates detailed text prompts. These prompts are designed to describe the educational content 106 in a way that can be effectively used by the AI engine 126 (not shown in the figure) to generate images.

Further, image generation 508 takes place using these prompts to produce photorealistic background images. The AI engine 126 interprets the text prompts and creates images that are visually appealing and contextually relevant to the educational content 106. Finally, the background image generation process 200 concludes with the generation of the photorealistic background image 510 as the output, where the generated images are outputted. These background images are designed to enhance the educational experience by providing visual representations that are in correspondence with the educational content 106.

The above background image generation process 200 would be clearer with the following example. Consider a Grade 5 science lesson on the solar system to illustrate the block diagram 500. The educational content 106 is taken as input 502, which includes specific details such as the subject, say, Science, the educational standard, say, Grade 5, a question, say, How many planets are there in the solar system?, and the answer, The planets in our solar system are Mercury, Venus, Earth, Mars, Jupiter, Saturn, Uranus, and Neptune.

The input data is fetched 504 using the data collector 118, ensuring that all the necessary information about the solar system is gathered and ready for processing. This step consolidates the subject, standard, question, and answer into a structured format. Based on the collected educational content 106, the prompt generator 124 generates the text prompt 506. For example, it might generate a prompt like, ‘Create an image of the solar system showing all eight planets in their respective orbits around the sun.’ This prompt is designed to capture the educational content 106 in a way that can guide the AI engine 126 in creating a relevant background image.

The AI engine 126 utilizes these prompts to generate the photorealistic background images 508, and the AI engine 126 interprets this text prompt to produce a photorealistic image. The AI engine 126 reads the prompt and generates the background image depicting the solar system with all eight planets accurately placed in their orbits around the sun.

Finally, the background image generation process 200 concludes with the generation of the photorealistic background image as output 510. The generated image, which vividly represents the solar system and its planets, is then presented to the users. This visually engaging image enhances the learning experience by providing a clear and accurate illustration of the topic being studied, making it easier for users to understand and remember the information.

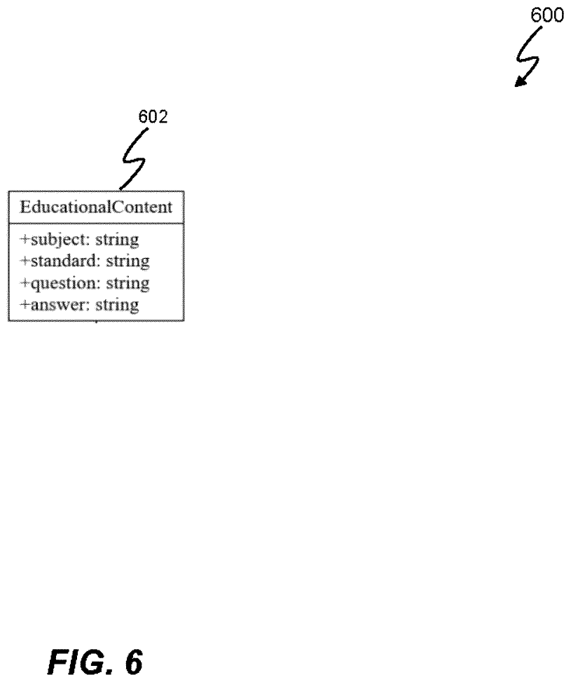

FIG. 6 depicts an exemplary data structure 600 for organizing data to hold the educational content 106.

The data structure 600 illustrates an EducationalContent 602 designed to capture essential elements of educational content 106, such as questions 108, answers 110, and educational standards 114. The EducationalContent 602 node has specific fields: subject, standard, question, and answer. The subject field holds the name of the subject area (e.g., mathematics, science), the standard field indicates the educational standard or level (e.g., Grade 5, AP), and the question and answer fields store the actual educational content 106 in the form of a question and its corresponding correct answer. This organized data structure 600 facilitates efficient retrieval and manipulation of educational data, making it easier to manage and utilize within the online learning platform 102.

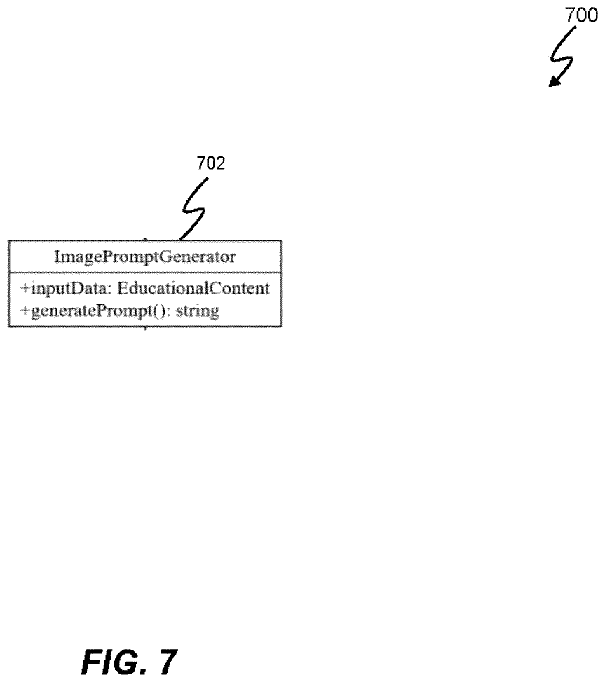

FIG. 7 depicts an exemplary data structure 700 for organizing data to generate text prompts for image generation based on the educational content 106.

The data structure 700 illustrates an ImagePromptGenerator node 702 designed to enable the generation of detailed text prompts for generating background images based on educational content 106. The ImagePromptGenerator node 702 includes an inputData field linked to the EducationalContent 602 data structure 600, serving as the input source containing questions, answers, and educational standards 114. The primary function within this data structure 700 is prompt generation, which processes the educational content 106 and outputs a text-based prompt. This text-based prompt acts as a detailed and contextually appropriate prompt for guiding and constraining theAI engine 126 to create relevant and visually appealing background images. This organized approach ensures that the image prompts are accurately derived from the educational database 112, enhancing the overall user experience on the online learning platform 102.

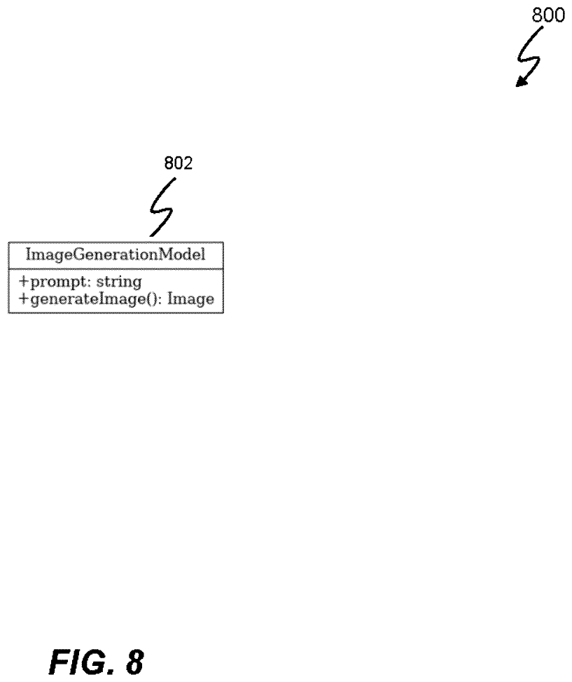

FIG. 8 depicts an exemplary data structure 800 for organizing data to generate images based on the prompts provided by the user.

The data structure 800 illustrates an ImageGenerationModel 802 designed to encapsulate the functionality of generating background images based on provided text prompts. The ImageGenerationModel 802 includes two main fields namely, prompt and the generated image. The prompt field contains the text-based prompt generated using the ImagePromptGenerator node 702, which serves as a detailed description or instruction for background image creation. The generatelmage( ) function takes this prompt as input and produces the background image as output. This structured approach ensures that the background image generation process 200 is efficient and the images created are closely aligned with the detailed prompts, resulting in visually coherent and contextually relevant background images that enhance the educational content 106.

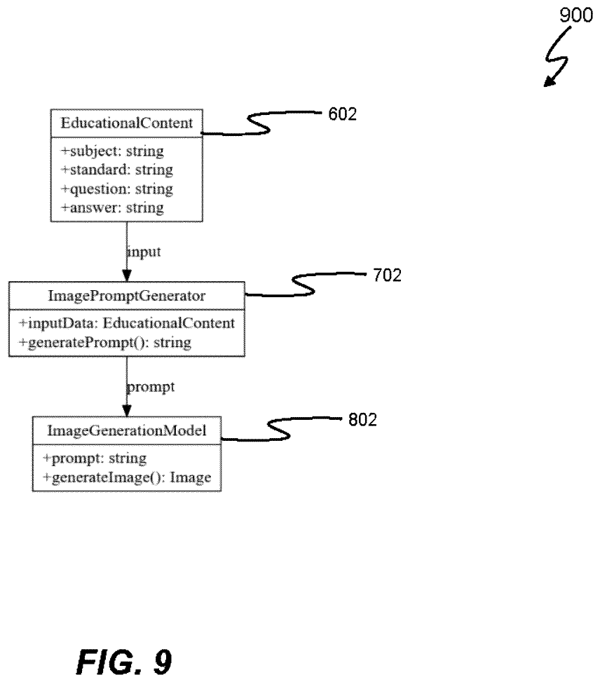

FIG. 9 depicts an exemplary data structure 900 for organizing data to show how the data structures of FIGS. 6-8 interact with each other to generate the background image.

The data structure 900 illustrates how various data structures work together to generate contextually relevant background images in the AI-driven online learning platform 102. The data structure 900 includes the EducationalContent data structure 602, which includes key elements such as subject, educational standard, questions, and answers. This data structure 602 serves as the foundational input for the background image generation system 100, containing all necessary educational content 106.

Next, the ImagePromptGenerator data structure 702 interacts with the EducationalContent data structure 602. The ImagePromptGenerator data structure 702 takes the educational content 106 as input and processes it to generate detailed text prompts. This step is crucial as it transforms educational content 106 into a form that can be effectively used to guide the AI engine 126 in background image generation. The generatePrompt( ) function within this component plays a key role in generating these descriptive prompts based on the input data.

Finally, the ImageGenerationModel data structure 802 receives the prompts generated by the ImagePromptGenerator data structure 702. The ImageGenerationModel data structure 802 utilizes text-to-image-converter 132, which is responsible for converting the textual prompts into actual images. The generatelmageo function uses the detailed descriptions provided by the prompts to create visually appealing and contextually appropriate background images that align with the educational content 106.

The data structure 900 visually represents these interactions: the EducationalContent data structure 602 feeds into the ImagePromptGenerator data structure 702, which then provides the generated prompts to the ImageGenerationModel data structure 802. This sequence ensures a seamless flow from educational content 106 to prompt generation and ultimately to image creation, enhancing the overall learning experience with contextually relevant visuals.

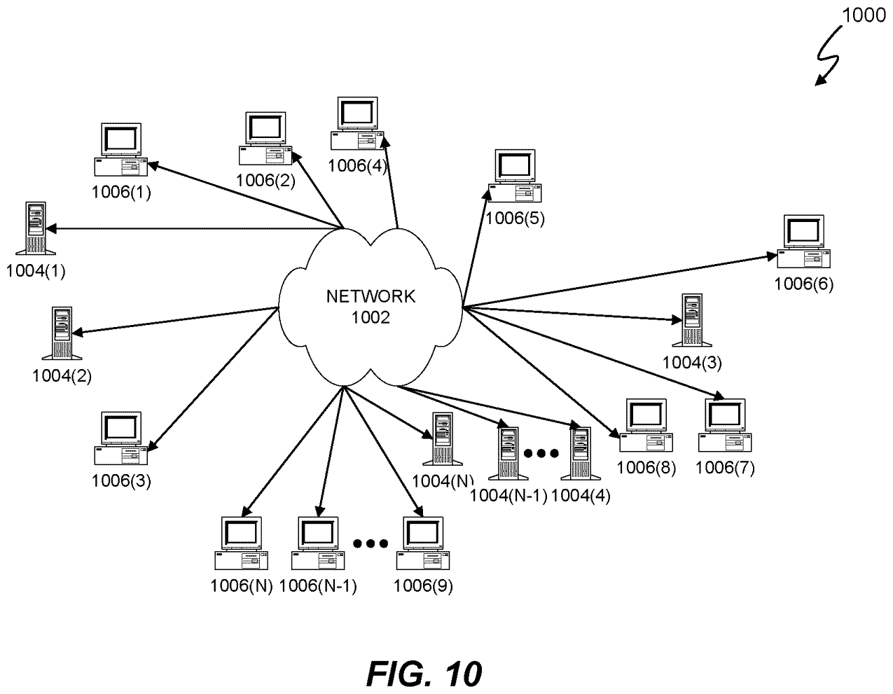

FIG. 10 is a block diagram illustrating a network environment in which a background image generation system 100 and process 200 based on the educational content 106 provided to the user using an online learning platform 102 may be practiced. Network 1002 (e.g. a private wide area network (WAN) or the Internet) includes several networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example, communications channels providing T1 or OC3 service. Client computer systems 1006(1)-(N) typically access server computer systems 1004(1)-(N) through a service provider, such as an internet service provider (“ISP”) by executing application-specific software, commonly referred to as a browser, on one of client computer systems 1006(1)-(N).

Client computer systems 1006(1)-(N) and server computer systems 1004(1)-(N) are specialized computers programmed to improve conventional computer systems to implement and utilize the background image generation system 100 based on the educational content 106 provided to the user using an online learning platform 102. The type of computer system that can be specially programmed to implement and utilize the background image generation system 100 based on the educational content 106 provided to the user using an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the background image generation system 100 based on the educational content 106 provided to the user using an online learning platform 102 can be implemented using code stored in a tangible, non-transient computer-readable medium and executed by one or more processors. In at least one embodiment, the background image generation system 100 based on the educational content 106 provided to the user using an online learning platform 102 can be implemented completely in hardware using, for example, logic circuits and other circuits including field programmable gate arrays.

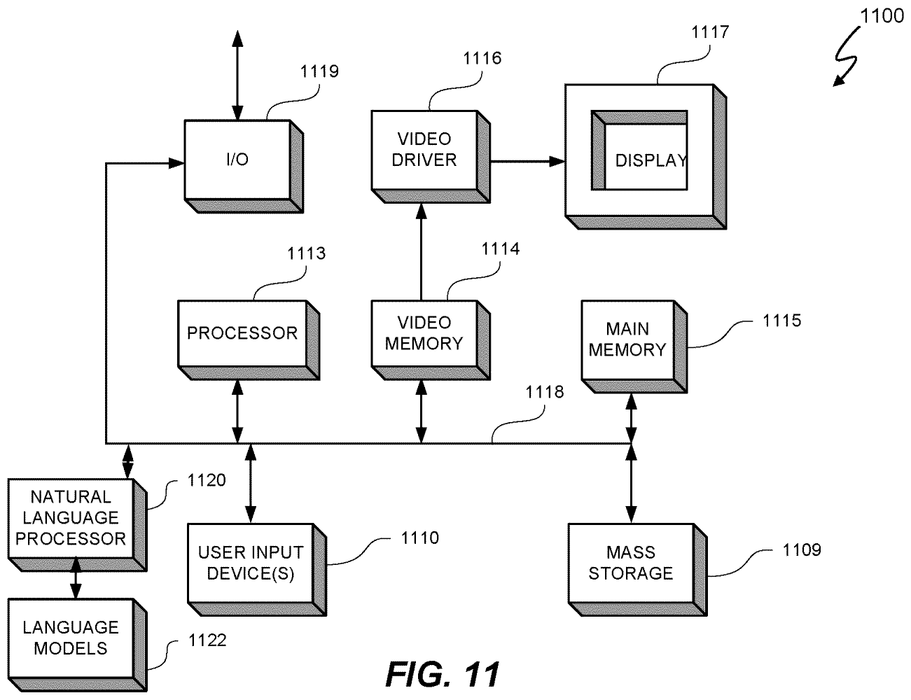

Embodiments of the background image generation system 100 based on the educational content 106 provided to the user using an online learning platform 102 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114, and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer system via a telephone link or to the Internet via an ISP. I/O device(s) 1119 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1109, into main memory 1115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 consists of dynamic random access memory (DRAM). Video memory 1114 is a dual-ported video random access memory. One port of the video memory 1114 is coupled to the video amplifier 1116. The video amplifier 1116 is used to drive the display 1117. Video amplifier 1116 is well-known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The background image generation system 100 based on the educational content 106 provided to the user using an online learning platform 102 may be implemented in any type of computer system programming or processing environment. It is contemplated that the background image generation system 100 based on the educational content 106 provided to the user using an online learning platform 102 might be run on a stand-alone computer system, such as the one described above. The background image generation system 100 based on the educational content 106 provided to the user using an online learning platform 102 might also be run from a server computer systems system that can be accessed by a plurality of client computer systems interconnected over an intranet network. Finally, the background image generation system 100 based on the educational content 106 provided to the user using an online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of guiding and constraining an AI (Artificial Intelligence) engine to generate a background image in correspondence to educational content provided to a user using an online learning platform, the method comprises:
executing code using one or more processors of a computer system to cause the computer system to perform operations comprising:
collecting one or more educational content, wherein the one or more educational content includes questions and their correct answers provided to the user during the online learning session, educational standard, and educational curriculum of the user;
analyzing the educational content by integrating all the relevant information from the education content to create a detailed narrative for background image generation;
generating prompts to guide and constrain the AI engine, using the analyzed educational content, and transforming the educational content into a detailed text prompt suitable for background image creation using natural language processing techniques;
transferring the generated prompts to the AI engine for converting the text prompt into a realistic background image; and
receiving a realistic background image in correspondence to the educational content, wherein the background image is generated specifically to enhance user engagement and experience that is visually appealing and contextually appropriate.

2. The method of claim 1 wherein the one or more educational content is collected from the online learning platform and educational databases.

3. The method of claim 1 wherein analyzing the educational content further comprises:
extracting key information from the educational content, including questions, correct answers, educational standards, and curriculum;
utilizing machine learning algorithms to identify patterns and relationships within the educational content to determine their context and relevance;
classifying the educational content based on curriculum, educational standards, and subject matter, ensuring that the detailed narrative of the background image is mentioned in the prompts.

4. The method of claim 1 wherein the prompts are generated by utilizing the text details which focus on image synthesis parameters, including visualization areas, scene settings, mood, lighting, color schemes, and camera angles.

5. The method of claim 1 wherein the generation of prompts for guiding the AI engine further comprises:
specifying a visual style for the background image based on the educational standard and curriculum of the user by analyzing the educational standard to determine the appropriate visual style for the background image, such as using cartoon illustrations for younger age groups or realistic 3D images for advanced subjects;
integrating the visual style specifications into the text prompt, including color details, brightness, camera angle, scene setting, and so on; and
adapting the visual style to reflect subject-specific themes, such as historical accuracy for history lessons, or scientific diagrams for science subjects, ensuring that the generated background image is visually appealing and contextually relevant to the educational material.

6. The method of claim 1 wherein the background image generation utilizes real-time data analysis to dynamically adjust image synthesis parameters based on ongoing user interactions and learning progress.

7. The method of claim 1 wherein the generated background image is a single-image narrative that depicts the educational content in a single visual representation, providing enhanced and engaged learning to the user.

8. The method of claim 1 wherein the AI engine employs deep learning techniques, including generative adversarial networks (GANs) and transformer architectures, to enhance the realism and artistic quality of the generated background image based on the transferred prompts.

9. A system to guide and constrain an AI (Artificial Intelligence) engine to generate a background image in correspondence to educational content provided to a user using an online learning platform comprises:
one or more processors; and
a memory, coupled to the one or more processors, storing code that when executed cause the one or more processors to perform operations comprising:
collecting one or more educational content using a data collector, wherein the one or more educational content includes questions and their correct answers provided to the user during the online learning session, educational standard, and educational curriculum of the user;
analyzing the educational content using an analyzer by integrating all the relevant information from the education content to create a detailed narrative for background image generation;
generating prompts using a prompt generator to guide and constrain the AI engine, using the analyzed educational content, and transforming the educational content into a detailed text prompt suitable for background image creation using natural language processing techniques;
transferring the generated prompts to the AI engine for converting the text prompt into a realistic background image using an image generator; and
receiving a realistic background image in correspondence to the educational content, wherein the background image is generated specifically to enhance user engagement and experience that is visually appealing and contextually appropriate.

10. The system of claim 9 wherein the data collector retrieves the educational content from various sources, including the online learning platform, and educational databases.

11. The system of claim 9 wherein the generated background image is displayed to the user on a user interface integrated within the online learning platform.

12. The system of claim 9 wherein the generated background images are stored in a cloud database accessible to the online learning platform for reuse and reference in future online learning sessions.

13. The system of claim 9 wherein the background image generation further comprises:
neural network module optimized for real-time processing and adaptation of image synthesis parameters, ensuring timely generation of contextually appropriate visuals aligned with educational standards.

14. The system of claim 9 wherein the image generator utilizes deep learning architectures, including generative adversarial networks (GANs) and transformer models, to enhance the realism and contextual relevance of the generated background images.

15. The system of claim 9 wherein the one or more processors are configured with high-performance computing capabilities to expedite the background image generation process and reduce latency during online learning sessions.

16. The system of claim 9 wherein the AI engine adheres to a moderation policy prohibiting violent, adult, or hateful content, and blocks flagged prompts, returns an error with a notification to the user.
